(19) United States
(12) Patent Application Publication
(10) Pub. No.: US 2006/0262718 A1
(43) Pub. Date: Nov. 23, 2006

(54) Real-time retry limit-a system and method to maximize throughput and minimize packet loss of wireless local area networks

(75) Inventors: Qiong Li, Tappan, NY (US); Mihaela van der Schaar, Los Angeles, CA (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electrontcs N.V., Eindhoven (NL)

(21) Appl. No.: 10/547,714

(22) PCT Filed: Sep. 1, 2003
(86) PCT No.: PCT/IB03/03853

§ 371 Date: Jul. 12, 2006

Related U.S. Application Data
(60) Provisional application No. 60/409,670, filed on Sep. 10, 2002.
(60) Provisional application No. 60/432,855, filed on Dec. 12, 2002.

(51) Int. Cl. H04L 12/26

(52) U.S. Cl. 370/229; 370/468

(57) ABSTRACT

This invention provides a system and method to dynamically adapt a wireless link retry limit in real-time according to channel conditions and workload intensity in order to maximize MAC throughput and minimize packet loss. In wireless local area networks (WLANs), such as IEEE 802.11b or a, packets can get lost due to either link error or interface queue overflow. Retry is deployed by a wireless link as a link error protection mechanism to reduce packet loss due to link error. However, an improper configuration of this retry limit (such as too high) may cause more packet loss due to queue overflow than link error. The retry-limit adaptation system and method of this invention strikes a balance between queue drops and link losses. Consequently, it achieves much better network performance in terms of a significant reduction of overall packet loss when compared with situations where the retry limit is statically configured, as recommended by the current standard. For video applications, this dynamic adaptation can be configured in such a way that the video quality for a particular network condition is optimized.

### CLAIM OF PRIORITY

This application claims priority to an provision application No. 60/409,670, entitled “REAL TIME RETRY LIMIT ADAPTATION—A METHOD TO MAXIMIZE THROUGHPUT AND MINIMIZE PACKET LOSS OF WIRELESS LOCAL NETWORKS,” filed on Sep. 10, 2002.

### FIELD OF THE INVENTION

This invention relates to packet loss in wireless local area networks (WLANs). More particularly, this invention relates to adjusting the link retry limit to minimize packet loss in WLANs. Most particularly, this invention relates to a system and method for dynamically adapting the wireless link retry limit in real-time according to channel conditions and workload intensity to maximize MAC throughput and minimize packet loss.

### DESCRIPTION OF THE RELATED ART

According to present standards, the MAC layer of 802.11b (and a) does not dynamically adapt its retry limit to network conditions. Some commercially available 802.11b wireless interface cards do allow the card driver to reset the MAC's default retry limits (7 for ShortRetryLimit and 4 for LongRetryLimit) to different values to achieve differential protections for different types of traffic. However, there is no retry limit optimization or adaptation provided by these products. Most of the available commercial 802.11b cards simply disable card drivers to modify the MAC's retry limits.

### SUMMARY OF THE INVENTION

Thus, there is a need for a way to adapt and optimize the MAC's retry limit.

In wireless networking systems, such as 802.11b WLANs, see, e.g., FIG. 3, packet loss can occur for two different reasons:
Packets are dropped by the interface queue (queue overflow) 30, or
Packets are dropped by the link when the retry limit is reached 32.
   Queue overflow occurs when applications inject traffic into the interface queue at a higher rate than the rate at which the wireless link 32 can deliver this traffic. Link drops occur when the underlying wireless channel conditions (such as bit-error rate) become worse than designed for statistically and, thus, a packet cannot be successfully transmitted over the wireless link even after trying the maximum allowed number of retries determined by the retry limit.

For streaming applications, normally, the RTP/UDP combination is used instead of RTP/TCP for transport control. Unlike TCP, UDP has no inherent flow control mechanism. It is simply an open-loop transport protocol without any feedback for flow control. An application, using UDP, can send the packets into the interface queue at any rate it desires. Streaming applications, especially video streaming, can generate packets at a very high rate, sometimes in bursty patterns. When video streaming applications are deployed over WLANs, the network can easily be overwhelmed either due to temporary bursty traffic or sporadic degradation of the wireless links.

Simulation shows that if the retry limit is fixed, packet loss due to queue drops increase due to one or both of the following reasons:
high incoming traffic rate, or
high channel bit-error rate (due to interference, fading, mobility, etc), that increases the lifetime of the packets in the queue, since each packet is retransmitted several times. At some point, however, packet loss due to queue drops becomes the main cause of packet loss in WLANs.

Simulations have also shown that, for a fixed combination of the incoming traffic rate and channel bit-error rate, there exists an optimal setting for the retry limit that can achieve minimum overall packet loss (the sum of both queue and link drops). If workload and channel conditions do not change, then it is only necessary to set the retry limit with a simulated optimal value once, and the WLAN always achieve its best performance in terms of minimizing packet loss.

However in real networks, both workload conditions (including incoming packet rate and pattern) and channel conditions can change over time. There does not exist a fixed optimal retry limit that can be applied to all conditions.

Therefore, a practical way to approach optimality is to dynamically adapt the retry limit in a way that tends to make the retry limit setting approach its optimal value under changing workload and channel conditions.

Simulation reveals that when queue drops and link drops are balanced, overall drops are at their minimum. Under certain workload conditions and channel bit-error rates, queue drops monotonically increase with the increase of the setting of the retry limit, while link drops monotonically decrease. This observation leads to a very simple retry limit adaptation algorithm that is a preferred embodiment of the present invention, see FIGS. 1 and 2.

The system and method of the present invention can be used by all 802.11a(b) related products, such as network card designs and the implementation of card drivers, or any wireless communication system wherein the wireless link perform error protection by the means of multiple retransmissions.

### BRIEF DESCRIPTION OF THE DRAWINGS

FIG. 1 illustrates C code for a preferred embodiment of the present invention.

FIG. 2 illustrates a flow chart of the C code illustrated in FIG. 1.

FIG. 3 illustrates an implementation of the present invention in a wireless interface. (I modified this fig)

### DETAILED DESCRIPTION OF THE PREFERRED EMBODIMENTS

The present invention is an algorithm such that when the queue drop rate is higher than the link drop rate, the retry limit is reduced, otherwise the retry limit is increased.

Using this algorithm, a MAC layer can adapt its retry limit in a way that can track the varying optimal settings corresponding to dynamic network conditions. Simulations show the algorithm minimizes packet loss and maximizes network throughput, achieving much better network performance than without a retry limit adaptation.

The system and method of the present invention continuously measures both interface queue and MAC drop rates, and compares these two rates periodically. In a preferred embodiment, if the queue drop rate is higher than the MAC drop rate, the system and method of the present invention reduces the MAC retry limit by one. If the queue drop rate is smaller than the MAC drop rate, the system and method of the present invention increases the retry limit by one.

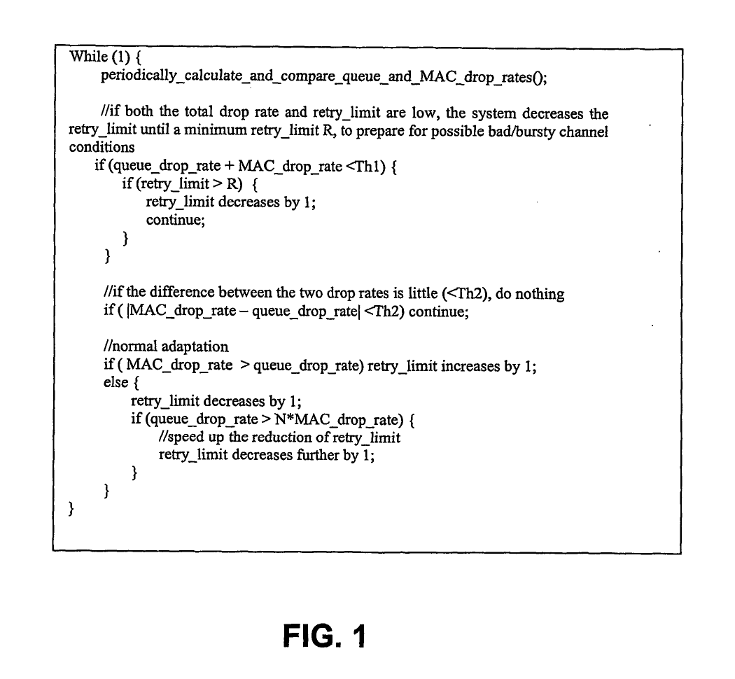

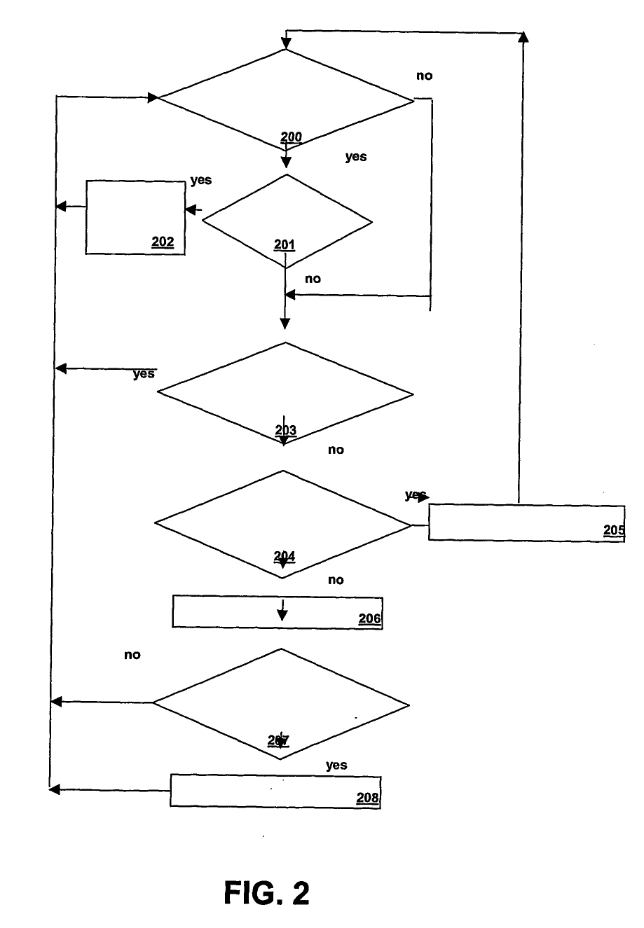

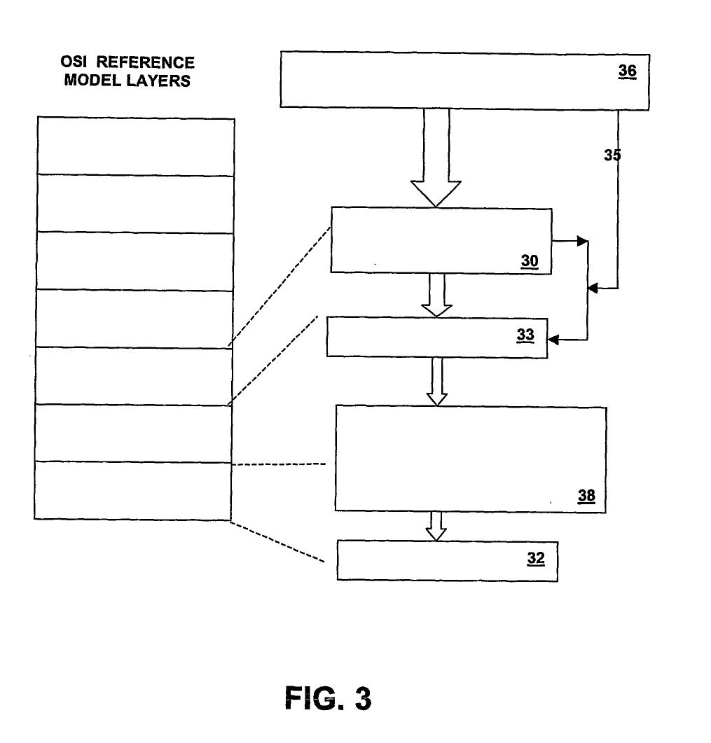

A preferred embodiment of a cross-layer algorithm is illustrated in C code in FIG. 1 and in a flow chart of its logic, in FIG. 2. This algorithm was developed and fined tuned through simulation. Typical examples for the thresholds used are: Th1=0.0001, R=4, Th2=0.01, N=10. As illustrated in FIG. 3, the interface queue 30 is normally maintained by the operating system (OS) 36 for a networking node and, therefore, the queue_drop_rate 35 can by measured within the kernel of the OS 36. The MAC drop rate can be measured by the driver 33 of the wireless network card in the physical layer PHY 32.

The OS 36 passes the queue_drop_rate 35 information periodically down to the driver 33, and the driver 33 compares the queue_drop_rate 35 with its own measure MAC drop rate, and then sets the MAC retry limit according to the algorithm. At step 200 the driver 33 compares the sum of the OS queue_drop_rate and its own measured MAC_drop_rate with a first threshold TH1 to determine if the total drop rate is low. If the comparison at step 200 indicates that the total drop rate is low then the driver 33 compares the retry_limit to a lower limit R step 201. If the retry_limit is set too high, it is decreased by one at step 202 until the pre-determined minimum retry limit R is reached. The combined testing at steps 200 and 201 are done to prepare for possible bad/bursty channel conditions.

At step 204 through 208, the algorithm attempts to obtain a similar drop rate for the both the interface queue queue_drop_rate and MAC MAC_drop_rate, since simulation shows that this strategy leads to the minimum packet-loss rate.

The foregoing description of the exemplary embodiment of the invention has been presented for the purposes of illustration and description. It is not intended to be exhaustive or to limit the invention to the precise algorithm disclosed. Many modifications and variations are possible in light of the above teaching. It is intended that the scope of the invention be limited not with this detailed description, but rather by the claims appended hereto.

1. A method for adapting a MAC retry limit to transmitting conditions in a wireless local area network, comprising the steps of:
a. initiating the retry limit R to a predetermined value.
b. at a pre-determined frequency, resetting the MAC retry limit according to a comparison of an interface queue drop rate (35) with a MAC drop rate;
c. monitoring the transmitting conditions of the network;
d. based on transmitting conditions of the network, resetting the MAC retry limit to obtain a similar drop rate for the interface queue (30) and the MAC (33); and
d. repeating steps c-d continuously.

2. The method of claim 1, wherein step b further comprises the steps of:
b.1 measuring the interface queue drop rate (35) queue_drop_rate for the interface queue (30);
b.2 measuring the MAC drop rate MAC_drop_rate for the current value of the MAC retry limit retry_limit; and
b.3 if the total drop rate=queue_drop_rate+MAC_drop_rate<Th1, where Th1 is a pre-determined threshold (200), reducing the retry limit retry_limit by 1 unless a pre-determined lower limit R has been reached (202).

3. The method of claim 2, wherein step c further comprises the steps of:
d.1 if |queue_drop_rate−MAC_drop_rate|>Th2, where Th2 is a pre-determined tolerance (203), performing the substeps of:
d.1.1 if MAC_drop_rate>queue_drop_rate, increasing the retry limit retry_limit by 1 (205);
d.1.2 if MAC_drop_rate<=queue_drop_rate, decreasing the retry limit retry_limit by 1(206); and
d.1.3 if queue_drop_rate>N*MAC_drop_rate, decreasing the retry limit by 1 further, where N is a predetermined positive number (207).

4. The method of claim 3, wherein Th1=0.0001, R=4, T2=0.01 and N=10.

5. A wireless local area network comprising a plurality of access points wherein each of said plurality of access points performs the method of claim 1.

6. A wireless local area network comprising a plurality of access points wherein each of said plurality of access points performs the method of claim 3.

7. A wireless interface comprising a wireless interface driver adapted to perform the method of claim 1.

8. A wireless interface comprising a wireless interface driver adapted to perform the method of claim 3.

9. A wireless interface comprising a wireless interface card (38) adapted to perform the method of claim 1.

10. A wireless interface comprising a wireless interface card (38) adapted to perform the method of claim 3.

11. A node of a wireless local area network, comprising:
a wireless interface comprising a wireless interface driver having a MAC retry limit and adapted to perform the method of claim 3; and
an operating system (36) that monitors the interface queue (30), measures the queue_drop_rate (35), and provides the measured queue_drop_rate (35) to the wireless interface driver,
wherein the MAC retry limit of the node is dynamically adapted to transmitting conditions of the network.

12. A node of a wireless local area network, comprising:
a wireless interface comprising a wireless interface card having a MAC retry limit and adapted to perform the method of claim 3; and
an operating system (36) that monitors the interface queue (30), measures the queue_drop_rate (35), and provides the measured queue_drop_rate (35) to the wireless interface card (38),
wherein the MAC retry limit of the node is dynamically adapted to transmitting conditions of the network.
